(19) United States
(12) Patent Application Publication
(10) Pub. No.: US 2006/0218756 A1
(43) Pub. Date: Oct. 5, 2006

(54) Junction system and procedure for joining a filiform element to a connection element

(76) Inventor: Alfonso Branca, Milano (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/559,567

(22) PCT Filed: May 24, 2004
(86) PCT No.: PCT/EP04/05540

§ 371 Date: Mar. 30, 2006

(30) Foreign Application Priority Data
May 28, 2003 (IT) MI2003A001065

(51) Int. Cl. F16G 11/00

(52) U.S. Cl. 24/130

(57) ABSTRACT

The junction system for joining a filiform element (2) to a connection element, possessing a tubular element (3) fitted on an end section of said filiform element (2) and substantially having an eye (4) for hooking said connection element.

The present invention refers to a junction system for joining a tensile stress-resistant filiform element to a connection element.

For some time cables used in multiple applications have been present on the market, for example for furnishing the support rigging for the mast of sailboats, or for the support of poles, or for the pretensioning of beams which must support a bending torque, or for still other structures.

Such cables must possess an adequate resistance to tensile stress, thus they are usually made in metallic material and in particular in steel.

Furthermore, such cables must be fastened to the ends, for example in a sailboat one end of the head is connected to the summit of the mast, and the other end to a connector fastened on the bridge.

Such cables notoriously present several drawbacks, including the fact that the constituent materials have an elevated density and an excessive overall weight for some applications.

For example, the weight of the cable which maintains the sailboat mast must be balanced by an additional weight applied to the boat keel. Since the arm of the moment exercised by the weight applied to the mast is considerably above the arm of the moment exercised by the weight applied to the keel, the value of the additional weight applied to the keel must be considerably above the weight applied to the mast. Naturally, this perversely affects boat stability and performance.

Another drawback of traditional cables consists in the fact that the extremities are damaged by wear and tear, continuous rubbing, impact, and shearing both by atmospheric agents and by the elements to which they are connected.

Still another drawback of traditional cables is due to the use of extremely expensive materials in order to confer optimal properties of resistance to tensile stress and stiffness.

A further drawback of traditional cables is due to the use of a generally complex system of junction to a connection element, which may be installed only by highly specialised personnel.

Finally, such traditional cables have the drawback of generating, due to their generally circular-section shape, an increased aerodynamic resistance independent from the direction of the fluid which impacts it.

The technical task which the present invention proposes is, therefore, that of achieving a junction system for joining a tensile stress-resistant filiform element to a connection element which permits the elimination of the above-mentioned technical drawbacks of the known technique.

Within the scope of this technical task one object of the invention is to achieve a junction system for joining a tensile stress-resistant filiform element to a connection element, in which the filiform element has a low density but notable properties of resistance to tensile stress and stiffness, such that it has an extremely limited overall weight, ideal for many applications.

Another object of the present invention is to supply a junction system for joining a tensile stress-resistant filiform element to a connection element which has a protection of the filiform element against damage by wear and tear, continuous rubbing, impact, and shearing both by atmospheric agents and by the elements to which they are connected.

Another object of the present invention is to supply a junction system for joining a tensile stress-resistant filiform element to a connection element, in which the filiform element has ideal properties of resistance to tensile stress and stiffness even if being achieved in an economical material.

A further object of the present invention is to achieve an easy-to-install junction system for joining a tensile stress-resistant filiform element to a connection element, even by not-highly-specialised personnel.

Last but not least object of the present invention is to present a device for reducing the aerodynamic resistance of a tensile stress-resistant filiform element subject to a fluid flux of variable direction.

The technical task, as well as these and other objects according to the present invention, are achieved by making a junction system for joining a filiform element to a connection element, characterised in that having a tubular element fitted on an end section of said filiform element and substantially having an eye for hooking said connection element.

According to a further aspect of the present invention, a procedure for achieving a system of junction of a filiform element to a connection element is revealed, characterised in that a tubular element is fitted on an end section of said filiform element, and said tubular element is shaped such that it determines an eye adapted to hook said connection element.

According to a third aspect of the present invention, a method (and a device) for reducing the aerodynamic resistance of a filiform element subject to a fluid flux of variable direction is revealed, characterised for the application of a highly aerodynamic wing profile along at least one section of said filiform element, supported and freely rotating around said filiform element such that it orients itself in the direction of the fluid flux which impacts it.

Other characteristics of the present invention are defined, moreover, in subsequent claims.

Further characteristics and advantages of the invention shall be more evident from the description of a preferred but not exclusive embodiment of the junction system according to the finding, illustrated as significant and non-limiting in the attached drawings, in which:

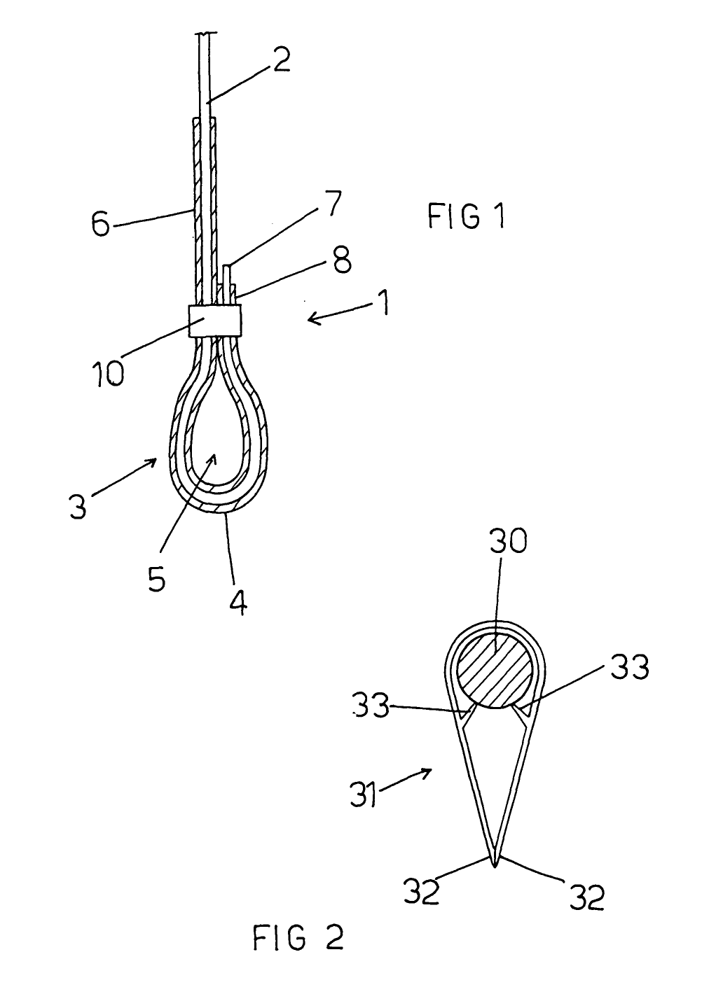

FIG. 1 shows a sectioned view of a first preferred embodiment of the junction system according to the present finding;

FIG. 2 shows a sectioned view of a device for reducing the aerodynamic resistance according to the present finding;

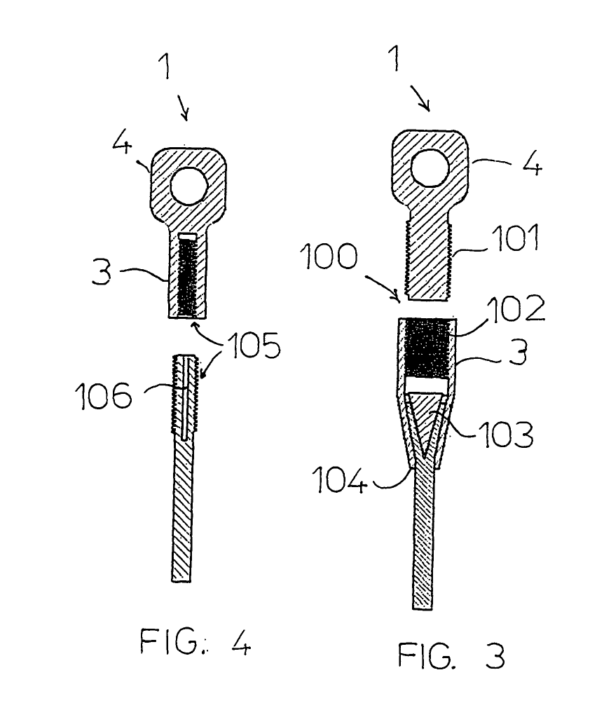

FIG. 3 shows an elevated side view of an axially-sectioned second preferred embodiment of the junction system according to the present finding; and

FIG. 4 shows an elevated side view of an axially-sectioned third preferred embodiment of the junction system according to the present finding.

Equivalent parts in the description will be indicated by the same reference number.

With reference to FIG. 1, a junction system 1 is shown for joining a filiform element 2 to a connection element (not shown).

The junction system 1 has a tubular element 3 fitted on an end section of the filiform element 2 and substantially defining an eye 4 for hooking the connection element.

In this embodiment, the tubular element 3 and the eye 4 are made in a single piece.

The tubular element 3 has a curved section 5 defining the eye 4, and at least a first substantially straight section 6 distal from the head 7 of the end section of the filiform element 2.

At least the first straight section 6 of the tubular element 3 may be bound to the filiform element 2, for example by way of an adhesive.

The first straight section 6 of the tubular element 3 has predetermined length such that the tensile stress force is at least partially or completely transferred from the filiform element 2 to the tubular element 3, corresponding exactly with the first straight section 6 of the tubular element 3.

The first straight section 6 of the tubular element 3 may be extended, also simply for protecting the filiform element 2 placed in its interior.

The tubular element 3 has flared end edges, in order to avoid transversely cutting the filiform element 2.

Preferably, the tubular element 3 then presents a second substantially straight section 8, proximal to the head 7 of the end section of the filiform element 2.

Preferably, the filiform element 2 may be of composite material, for example in continuous longitudinal fibre having a thermoplastic resin matrix, while the tubular element 3, may be in steel if there are no corrosion problems, stainless steel if there are corrosion problems, or also in another metallic material or in plastic in other applications.

When increased mechanical strength properties are required, the fibres of the composite material may be of carbon, aramide, S glass or PBO. Otherwise, for reasons of economy and where lower mechanical properties are required, glass fibres may be employed. It may be advantageous to combine different composite materials to make the filiform element 2, for example an internal composite material of carbon fibres to confer the desired stiffness and an external composite material in aramide to confer resistance to abrasion. The thermoplastic matrix may be made in TPU, nylon, PEEK or polypropylene.

The filiform element 2 may be presented in the form of a composite round bar, or a plurality of composite round bars, aligned or intertwined among themselves.

The resinous matrix of the constituent composite of the filiform element 2 may alternatively be of thermosetting type.

If the round bars are not of circular transversal section, they may be assembled such that they give rise to a substantially circular configuration.

The filiform element 2 may also be presented in plastic or metal, for example steel, where weight is not a critical factor in the application.

The facing surfaces of the tubular element 3 and the filiform element 2 may define the spaces specifically made to contain the adhesive material.

The filiform element 2 may have a protective coating (not shown) against ultraviolet rays and/or against attacks of chemical nature and/or against damage of mechanical origin.

The filiform element 2 and/or its protective coating may additionally have both a predetermined coloration for identifying the diameter of the filiform element 2 and/or for visually indicating the filiform element 2, and length markers for facilitating the measurement of the filiform element 2 during the making of the junction system.

The junction system has means of locking the eye 4 closing, in particular formed by a ring 10 applied around the neck of the eye 4.

The procedure for making a system of junction of the filiform element 2 to a connection element foresees fitting the tubular element 3 on the end section of the filiform element 2, and to form the tubular element 3 such that it defines the eye 4.

In such a procedure, as said, the filiform element 2 may be bound to the tubular element 3 in order to more efficiently transfer the tensile stress load from one to the other.

The bond, as seen, may be achieved with an adhesive applied to the outer surface of the filiform element 2 before the introduction of this last into the tubular element 3, or by applying a low-viscosity adhesive on the interface between the filiform element 2 and the tubular element 3 after the moulding of these last, the adhesive penetrating by capillarity or by applying a vacuum or pressure at an end of the tubular element 3.

Alternatively, if the filiform element 2 is of composite thermoplastic material, the bond may derive from the at least partial melting of the resinous matrix of the composite material which adheres to the inner surface of the tubular element 3.

Naturally, the length required for the transfer of the load from the filiform element 2 to the tubular element 3 depends on a plurality of factors including, among others, the quality of the interface and the properties of the adhesive. A tighter contact at the interface and/or a higher adhesion coefficient reduces the transfer length.

To make a system of junction of the filiform element 2 in thermoplastic composite material to the connection element, a kit comprising a folding device (not shown) for the tubular element 3 will suffice, having means of heating adapted to simultaneously heat the filiform element 2 and the tubular element 3 to a predetermined temperature at which the filiform element 2 and the tubular element 3 become malleable, to be shaped such that they substantially define the eye 4.

Optionally, the heating and the folding of the filiform element 2 and the tubular element 3 may be undertaken by especially dedicated devices.

For example, the heating may be executed by a hot air pistol, by an oven, by heated metallic plates etc. while the folding may be achieved by a traditional bending machine.

Naturally, if the resinous matrix of the composite is thermosetting, the folding is executed at cool temperatures.

One particular junction procedure is described below.

The filiform element 2 is a bar with 5 mm diameter and 1,000 mm length, made in a thermoplastic composite material of carbon fibre embedded in an ETPU matrix. The tubular element is a stainless steel tube of 300 mm length.

The end 200 mm of the tube is heated to 160° C.

The tube and the bar in its interior are folded such that they form a hooking eye; they are then cooled.

Two stainless steel rings of 10 mm length are flattened such that they assume an oval shape, the end of the not-yet-shaped bar inserted in them.

The end of the not-yet-shaped bar is inserted into a second stainless steel tube of 300 mm length, after which the other end of the bar is shaped in order to form the second hooking eye.

Each ring is seamed at the neck by a corresponding eye.

Finally, each eye is hooked to a corresponding connection element.

With reference now to FIG. 3, the junction system 1 has removable connection means 100 between the tubular element 3 and the eye 4.

Such means of connection comprise a threaded stem 101 which extends from the eye 4 and screws into a first end 102 of the tubular element 3.

The junction system 1 has an anti-unthreading element 103 adapted to prevent the unthreading of the filiform element 2 from a second end 104 of the tubular element 3.

The anti-unthreading element 103 consists of a pin inserted axially in correspondence with the end of the filiform element 2 positioned in the tubular element 3, and has maximum cross section greater than the inner clearance of the tubular element 3.

In a preferred form, the pin has a conic or frustoconic shape, in order to facilitate the centring with respect to the generally cylindrical filiform element 2, and to obtain a homogenous deformation of the filiform element 2 during the penetration.

The filiform element 2 is preferably of thermoplastic composite material, directly or indirectly heatable to a softening temperature adapted to permit the penetration of the pin.

The filiform element 2 softening may be obtained by an external heat source applied directly to it, or by the friction which is generated during pin penetration, or by heating the pin first and/or during its insertion, or by heating the tubular element first and/or during pin insertion.

In the junction system 1 now illustrated the filiform element 2 is axially hollow in order to facilitate the pin penetration.

The filiform element 2 may more generally have full or empty or hollow section in order to be lighter.

With reference now to FIG. 4, the junction system 1 presents the eye 4 in a single piece, with the tubular element and the means of screw connection 105 between the inner side surface of the tubular element 3 and the outer side surface of the end section of the filiform element.

At least in correspondence with the zone of engagement between the threading of the filiform element 2 and the counter-threading of the tubular element 3 which defines such screw connection means, an axial discharge 106 of the filiform element 2 is foreseen which permits this last a radial deformation.

Preferably, in fact, the threading of the filiform element 2 is preferably obtained by inserting a pin in the axial discharge 106 in order to radially push the filiform element 2 from the inside toward the outside against the wall of a mould having the impression of the threading.

The filiform element 2 of the embodiments illustrated until now may be constituted in its entirety by poltruded longitudinal fibres.

Nevertheless it is equally conceivable that the filiform element 2 has a first section in poltruded longitudinal fibre, comprising the end section on which the tubular element 3 is fitted, and a second section extending from the first section in free or intertwined non-poltruded longitudinal fibres.

According to another aspect, the present invention reveals a method for reducing the aerodynamic resistance of a filiform element subject to a fluid flux of variable direction.

Such method foresees the application of an element of wing profile along at least a section of the filiform element, supported and freely rotating around the filiform element such that it orients itself in the direction of the fluid flux which impacts it.

An element with highly aerodynamic wing profile is illustrated in FIG. 2, which as an example makes reference to a shroud 30, in particular in composite material, which may be used to reinforce the vertical mast of a sailboat.

As known, the aerodynamic resistance D of a body struck by a fluid flux is expressible as:
D=Cₓ×L×W×V²

Where Cₓ is a coefficient which accounts for the body shape, L is the length of the body, W is the diameter of the body, and V is the relative velocity between the body and the fluid.

It should be noted that with L, W and V equivalent the wing profile of the aerodynamic element here illustrated has a Cₓ substantially equal to half that of the circular section of the shroud.

The element with highly aerodynamic profile is constituted by a wing-shaped foil 31 having elastically-pliable opposing edges 32 for the snap-lock introduction of the shroud 30.

The foil 31 is made from a plastic extrusion, preferably coloured so that it results easily visible.

The foil 31 has additionally at least a first extension, in particular two extensions 33, jutting out from its inner surface to join the foil 31 to a precise point on the longitudinal length of the shroud.

Possibly, the foil 31 may have a plurality of extensions (not shown) jutting out from the inner surface, for example angularly-spaced and radially-oriented with respect to the shroud 30, in order to join the foil 31 to a precise point on the longitudinal length of the shroud 30 having a substantially smaller diameter than that of the maximum chord of the curved part of the foil 31.

In such a manner the foil also operates as an element of protection of the shroud from accidental impact.

The junction system for joining a filiform element to a connection element thus conceived is susceptible to numerous modifications and variants, all coming under the scope of the inventive concept; in addition, all details may be substituted by technically-equivalent elements.

In practice, any materials of any size may be used, according to the requirements and to the state of the art.

1. A junction system for joining a filiform element to a connection element, characterized in that it has a tubular element fitted on an end section of said filiform element and substantially having an eye for hooking said connection element, the filiform element consisting of a single composite round bar matins with the tubular element alone a continuous side contacting surface.

2. The junction system according to claim 1, characterized in that said tubular element and said eye are made in a single piece.

3. The junction system according to claim 2, characterized in that said tubular element and said eye are made separately.

4. The junction system according to claim 3, characterized in that said tubular element has a curved section defining said eye, and at least a first substantially straight section distal from the head of said end section of said filiform element.

5. The junction system according to claim 1, characterized in that means for bonding said tubular element to said filiform element are present, in such a manner as to efficiently transfer the tensile stress force from said filiform element to said tubular element.

6. The junction system according to claim 5, characterized in that said means for bonding said tubular element to said filiform element comprise an adhesive or a chemical bond between said tubular element and said filiform element.

7. The junction system according to claim 4, characterized in that said first straight section of said tubular element has a predetermined length such that the tensile stress force is at least partially or completely transferred from said filiform element to said tubular element in correspondence with said first straight section of said tubular element.

8. The junction system according to claim 4, characterized in that said tubular element has a second substantially straight section proximal to the head of said end section of said filiform element.

9. (canceled)

10. The junction system according to claim 1, characterized in that a matrix of said filiform element of composite material is thermoplastic.

11. (canceled)

12. The junction system according to claim 1, characterized in that said tubular element is steel.

13-14. (canceled)

15. The junction system according to claim 1, characterized in that said filiform element has a protective coating against ultraviolet rays and/or against attacks of chemical nature and/or against damage of mechanical origin.

16. The junction system according to claim 1, characterized in that said filiform element and/or said protective coating have a predetermined coloration for identifying the diameter of said filiform element and/or for visually indicating said filiform element.

17. The junction system according to claim 1, characterized in that said filiform element or said protective coating have length markers for facilitating measurement of said filiform element during the making of the junction system.

18. The junction system according to claim 1, characterized in that it has means of locking said eye's closing.

19. The junction system according to claim 18, characterized in that said locking means are formed by a ring applied around the neck of said eye.

20. The junction system according to claim 1, characterized in that said tubular element has flared end edges.

21. The junction system according to claim 1, characterized in that it has removable connection means between said tubular element and said eye.

22. The junction system according to claim 21, characterized in that said connection means comprise a threaded stem which extends from said eye and screws into a first end of said tubular element.

23. The junction system according claim 21, characterized in that it has an antiunthreading element adapted to prevent the unthreading of said filiform element from a second end of said tubular element.

24. The junction system according to claim 23 characterized in that said anti-unthreading element consists of a pin inserted axially in correspondence with the end of said filiform element positioned in said tubular element, and having maximum cross section greater than the internal clearance of said tubular element.

25. The junction system according to claim 23, characterized in that said pin is conical or frustoconical.

26. The junction system according to claim 23, characterized in that said filiform element is of composite thermoplastic material, directly or indirectly heatable to a softening temperature adapted to permit the penetration of said anti-unthreading element.

27. The junction system according to claim 1, characterized in that it presents means of screw connection between the outer side surface of said end section of said filiform element and the inner side surface of said tubular element.

28-29. (canceled)

30. A procedure for joining a filiform element to a connection element, characterized in that a tubular element is fitted on an end section of said filiform element, said tubular element shaped such that it defines an eye adapted to hook said connection element, the filiform element being a composite round bar heated simultaneously with the tubular element to a predetermined temperature at which both become malleable in order to be shaped to define the eye.

31. (canceled)

32. The procedure for achieving a system of junction of a filiform element to a connection element according to any one preceding claim, characterized in that it joins said filiform element to said tubular element in order to transfer the tensile stress load from one to the other.

33. A kit for achieving a system of junction of a filiform element to a connection element, characterized in that it comprises one said filiform element, resistant to tensile stress, of thermoplastic composite material, one tubular element to fit on an end section of said filiform element, and a device for folding said tubular element having means of heating adapted to simultaneously heat said filiform element and said tubular element to a predetermined temperature in which said filiform element and said tubular element become malleable, in order to be shaped such to substantially define a hooking eye to said connection element.

34. A method for reducing the aerodynamic resistance of a filiform element subject to a fluid flux of variable direction, characterized in that attached along at least one section of said filiform element is at least one element with highly aerodynamic wing profile, supported and freely rotating around said filiform element such that it orients itself in the flux direction which impacts it.

35. A device for reducing the aerodynamic resistance of a filiform element subject to a fluid flux of variable direction, which is characterized in that it comprises at least one highly aerodynamic wing element attached along at least one section of said filiform element and supported and freely rotating around said filiform element such that it orients itself in the flux direction which impacts it.

36. The device according to claim 35, characterized in that it is in the form of a wing-shaped foil, having elastically-pliable opposing edges for the snap-lock introduction of said filiform element inside said element with aerodynamic profile.

37. The device according to claim 35, characterized in that it is formed in plastic extrusion.

38. The device according to claim 36, characterized in that said foil has at least a first extension projecting from the inner surface in order to join said foil to a precise point on the longitudinal length of said filiform element.

39. The device according to any claim 36, characterized in that said foil has a plurality of extensions projecting from its inner surface in order to join said foil to a precise point on the longitudinal length of said filiform element having substantially smaller diameter than that of the maximum chord of the curved part of said foil.

40. (canceled)
